(19) United States
(12) Patent Application Publication
(10) Pub. No.: US 2018/0095664 A1
(43) Pub. Date: Apr. 5, 2018

(54) TECHNIQUES AND ARCHITECTURES FOR EFFICIENT ALLOCATION OF UNDER-UTILIZED RESOURCES

(71) Applicant: salesforce.com, inc., San Francisco, CA (US)

(72) Inventors: James E. Walsh, Woodinville, WA (US); Sameer Tiwari, Fremont, CA (US)

(21) Appl. No.: 15/282,335

(22) Filed: Sep. 30, 2016

(51) Int. Cl. G06F 3/06; H04L 29/08; H04L 12/911

(52) U.S. Cl. CPC G06F 3/0604; H04L 67/2842; G06F 3/067; G06F 3/061; G06F 3/0631; H04L 47/82

(57) ABSTRACT

In a computing environment, a set of executing processes each having associated resources are provided. Aggregate resources for the computing environment include multiple different types of resources. A utilization level is determined for each of the resources within the computing environment to determine an unconsumed capacity for each of the resources below a utilization threshold. The utilization threshold is resource-dependent. One or more working sets of resources including unconsumed capacity of resources of a similar class are generated. The working sets are provided to a second plurality of processes. The first plurality of processes and the second plurality of processes are executed concurrently using the aggregate resources and at least one working set of resources.

### TECHNICAL FIELD

Embodiments relate to efficient utilization of resources. More particularly, embodiments relate to techniques for efficiently identifying non-utilized (or under-utilized) resources to be allocated for more efficient utilization. For example, in a multitenant environment, systems may be designed to satisfy peak loads

### BACKGROUND

Computing environments often include resources that are not fully utilized during normal operating conditions. For example, in a multitenant environment resources (e.g., processor capacity, memory space, bandwidth, cache memory access, database service) can be designed based on anticipated peak loads. However, during normal operation, many of these resources may be unused or lightly used. Thus, there may exist valuable resources that are not utilized as efficiently as possible.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of an architecture that can provide efficient allocation of under-utilized resources as described herein.

FIG. 2 provides an example of possible working set configurations.

FIG. 3 provides a graphical illustration of aggregation across four hosts with varying storage characteristics.

FIG. 4 is a flow diagram of one embodiment of a technique for aggregating and allocating underutilized resources.

FIG. 5 illustrates a block diagram of an environment where an on-demand database service might be used.

FIG. 6 illustrates a block diagram of an environment where an on-demand database service might be used.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

A typical host data center offers resources like memory, processor, network bandwidth and/or storage with varying degrees of characteristics. This may arise due to heterogeneous environments, natural decay of resources, intrinsic properties of the host(s) and/or network, or loads. The techniques described herein can provide a system that can aggregate resources with similar characteristics and expose them as distributed resources (called “working sets”) across any number of hosts. In one embodiment, a set of hosts can be grouped into a higher level construct referred to as a “section” and multiple sections can coexist in a single data center on different sets of hosts or form multiple sections across hosts for load distribution.

The techniques and architectures described herein can provide a future proof mechanism for sharing any type of sharable resource. That is, resources that are provided by new technologies (e.g., new types of memory, new types of data management) can be utilized in the same manner as part of an existing working set or as part of a new working set. The techniques and architectures described herein can help reduce or eliminate brownouts that can be caused when all or part of a system slows due to one or more slow resources (e.g., slow disk).

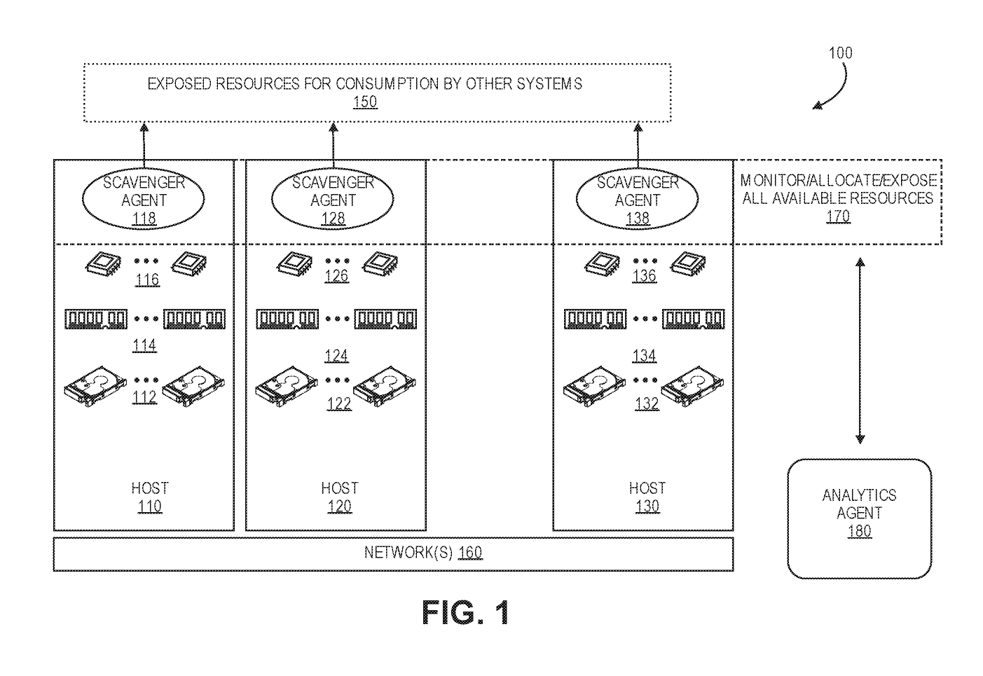

FIG. 1 is a block diagram of one embodiment of an architecture 100 that can provide efficient allocation of under-utilized resources as described herein. The example of FIG. 1 includes three host systems (110, 120, 130); however, any number of host systems can be supported. Further, the example of FIG. 1 illustrates only memory/storage resources that can be exposed for consumption by other systems; however, the example of FIG. 1 provides a basic example of the techniques described herein and not an exhaustive listing of possible uses. As described elsewhere in the present description, many types of resources can be exposed and/or reallocated as described herein.

Host systems 110, 120, 130 can be any type of computing platform having one or more resources that may be under-utilized. Host systems 110, 120, 130 can be interconnected by one or more networks 160 that can be any combination of wired and/or wireless networks.

While the example of FIG. 1 illustrates three systems that appear the same, the various resources may have different characteristics in different host systems. For example, the disk drives 112 of host 110 may have different characteristics (e.g., storage capacity, speed, bandwidth, reliability, energy consumption, available capacity), which may be the same or different than the disk drives (122, 132, respectively) of hosts 120, 130. Similarly, cache memory (114, 124, 134) and solid state drives (SSDs) 116, 126, 136 can have varying characteristics.

In one embodiment, each host system has an embedded scavenger agent (118, 128, 138) that functions to monitor and/or evaluate the utilization of one or more resources within the corresponding host system. In one embodiment, scavenger agents 118, 128, 138 have some control or influence over allocation of resources within the respective host systems. For example, if scavenger agent 128 determines that 50% of cache memory 124 is being utilized by host system 120, scavenger agent 128 can 50% (plus some buffer amount, for example, +5%, +10%) to be allocated to host system 120 and the remaining portion (e.g., 45%, 40%) can be exposed for use by other systems, for example, host 110 and/or host 130.

In one embodiment, each scavenger agent further functions to expose, advertise and/or otherwise indicate resources that are available in the host systems monitored by the respective scavenger agents. In one embodiment, a monitoring agent/entity 170 external to the host systems can collect information from one or more of the scavenger agents. In alternate embodiments, monitoring agent 170 can be provided by one or more of the host systems.

In one embodiment, unused resources and/or under-utilized resources can be exposed by the scavenger agents to allow other host systems to use these resources. Various techniques can be utilized to expose/advertise the availability of these resources 150. For example, a single listing or entity can provide identification and/or capacity available from other resources. A listing can be, for example, a table in a database, an XML file, etc. An agent/daemon/thread/entity can be responsible for managing information related to available scavenged resources and/or matching the resources to requests for additional resources.

In one embodiment, monitoring agent 170 can function to collect information from the various scavenging agents to expose all available resources to all (or a subset) of the host systems within a larger environment. For example, host systems 110, 120, 130 can be part of an on-demand services environment that functions to provide services to various users. An on-demand services environment can be, for example, a multitenant database environment, a customer relationship management (CRM) environment, etc. Various embodiments of on-demand service environments are described below.

In one embodiment, analytics agent 180 functions to gather utilization information from various hosts and can use this information to make load predications and/or provide this information to one or more load prediction agents to be used in making load predictions. Information can include, for example, historical statistical information such as cache utilization tracked by time of day. Any type of analytics can be utilized by analytics agent 180. Scavenging functionality is described in greater detail in U.S. patent application Ser. No. ______, filed ______, 2016 and entitled “TECHNIQUES AND ARCHITECTURES FOR EFFICIENT ALLOCATION OF UNDER-UTILIZED RESOURCES,” by James Walsh and Sameer Tiwari, which is incorporated by reference herein.

In one embodiment, within a data center having many physical computing systems, clustering techniques can be applied based on sets of features (e.g., throughput, latency, processor availability) to determine one or more groups of similar resource characteristics across these physical computing systems. Groups made this way perform in a more predictable manner than more random sets. Resources can be grouped together into working sets (as discussed above). Various embodiments can support any number of working sets across any number of host physical computing systems.

In one embodiment, these hosts can also be mapped into “availability zones” that can be utilized to provide high-availability services. Availability zones can be associated with units of failure. For example, storing multiple copies of data on a single disk results in very low availability if the disk were to crash. Storing the data across multiple disks on a single host is a level up in availability. Storing the data across multiple disks across multiple hosts is another level up (two total) in availability. Storing the data across multiple hosts across multiple racks is another level up (three total) in availability. Storing the data across multiple data centers is another level up (four total) in availability.

The following are a few examples to describe possible clustering strategies. A low performance dynamic random access memory (DRAM) might be equivalent to a high performance 3D XPoint storage and can be grouped together in a working set. A high performance hard disk might be equivalent to a low performance old solid state drive (SSD) and can be grouped together in a working set. Within a single hard drive there may be some blocks that are higher performance than other blocks and can be exposed as a separate working set. In one embodiment, each working set can expose an orthogonal feature of an availability zone.

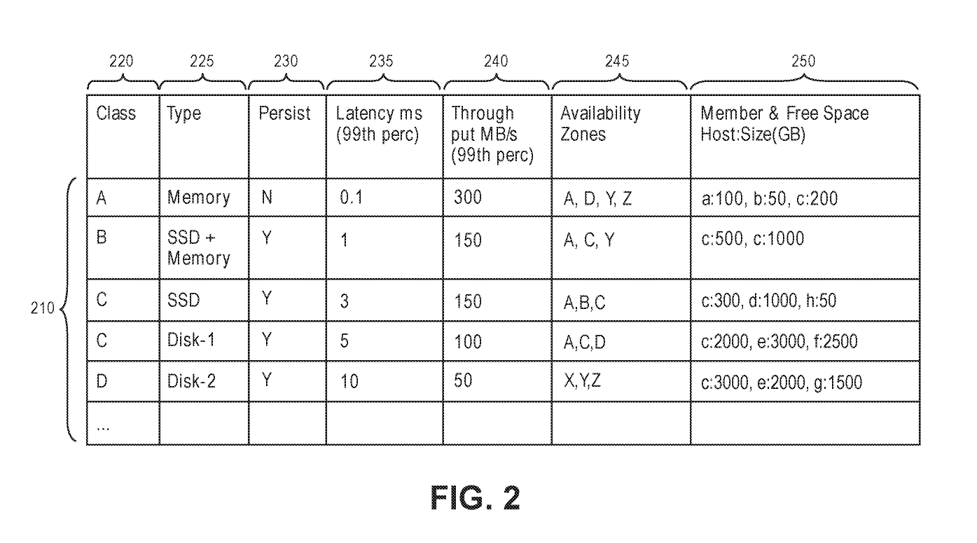

FIG. 2 provides an example of possible working set configurations. The example of FIG. 2 is for memory and storage resources; however, the techniques described are applicable to other types of resources as well. In one embodiment, the working sets are exposed/advertised for consumption as described above with respect to FIG. 1.

In the example of FIG. 2, working sets 210 can be organized by class 220. For example, a class “A” working set can be a higher performance working set than a class “B” working set, etc. The example of FIG. 2 provides specific characteristics that can be utilized for classification purposes; however, any relevant characteristics can be used.

In the example of FIG. 2, working sets are classified based on combinations of device type (e.g., memory, memory & SSD, disk) 225, whether or not it is a persistent store 230, latency 235, throughput 240, etc. In one embodiment, characteristics can also include availability zones 245 and free space sizes. In one embodiment, host naming and amount of free space available can be provided, 250. Thus, if a remote host is in need of high performance storage, a class “A” working set can be utilized, but if lower performance is satisfactory, a lower class (e.g., D) might be utilized. By organizing working sets by performance characteristics, resources can be more efficiently allocated.

In one embodiment, one or more aggregator agents operate within a computing environment to expose working sets and make the working sets available for use by other hosts. For example, working sets of memory/storage can be treated like a block or object in a storage system.

In one embodiment, an aggregation agent can run as multiple independent processes on a subset of hardware computing devices within a larger computing environment (e.g., on-demand services environment, described below) that can be coordinated via a distributed locking system. In one embodiment, there can be multiple queues that hold requests to the aggregator agent across different areas. IN one embodiment, each aggregator agent can have a near real time view of available working sets and can make independent decisions as to whether or not hosts from a working set can be grouped to make a cluster for higher-level utilization.

For example, if some system has a need for 1 TB of Class A memory, that system can send a request to one of the aggregator queues. Any aggregator can pull the request from the queue when ready and check the available working sets to determine if the request can be satisfied. If the aggregator agent can support the request, the aggregator agent will try to acquire resources from the working sets by acquiring locks for those resources/working sets.

In one embodiment, because multiple aggregator agents could request the same resource at the same time, the aggregator agents can depend on optimistic concurrency control for locking a resource/working set. This implies that updates to acquire a resource is atomic and only one commit will succeed. If there is a failure, the aggregator agent will back off and try again later.

In one embodiment, after the aggregator agent has successfully completed the allocation, it can had off the resource/working set to an application or, for example, to a distributed object or a block storage system.

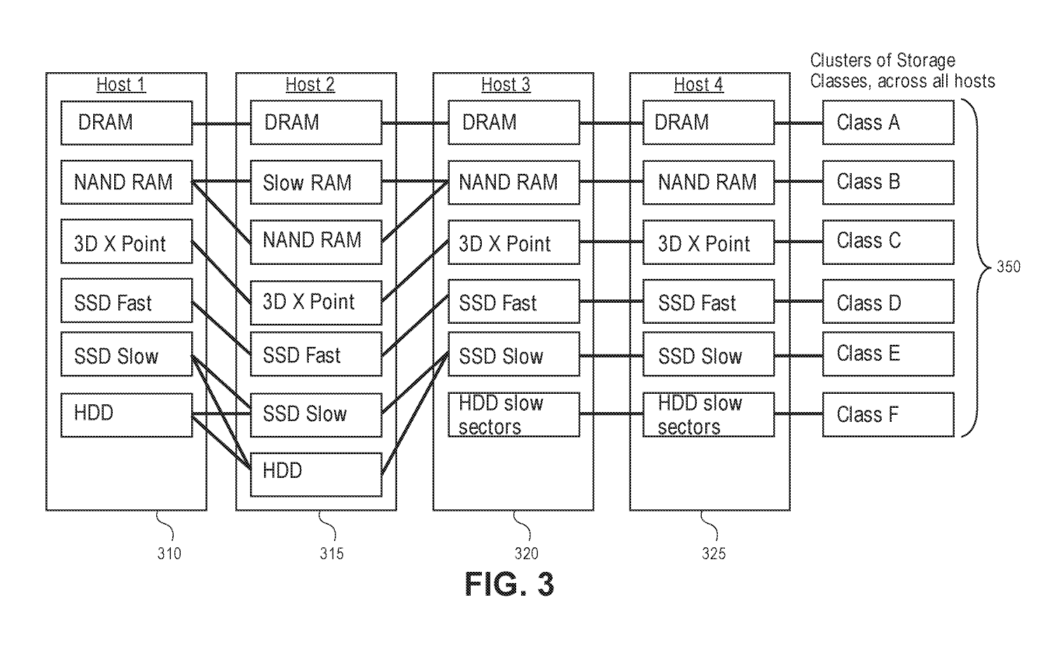

FIG. 3 provides a graphical illustration of aggregation across four hosts with varying storage characteristics. The example of FIG. 3 includes NAND RAM, and slow RAM that have been pooled into Class B. This would happen if, for example, the two resources have similar relevant performance characteristics. Similarly, in the example, of FIG. 3, slow SSD and HDD have been pooled into Class D. The example, of FIG. 3 is limited to memory/storage resources; however, the techniques described herein can be applied to any type of underutilized resource.

In the example of FIG. 3, hosts 310, 315, 320 and 325 have varying combinations of storage/memory resources that can be grouped into clusters 350. In the example of FIG. 3, DRAM from each host is Class A, NAND RAM and slow RAM is Class B, 3D XPoint memory is Class C, fast SSD memory is Class D, slow SSD and HDD is Class E, and slow HDD sectors are Class F. Other, different and/or additional classifications can be supported.

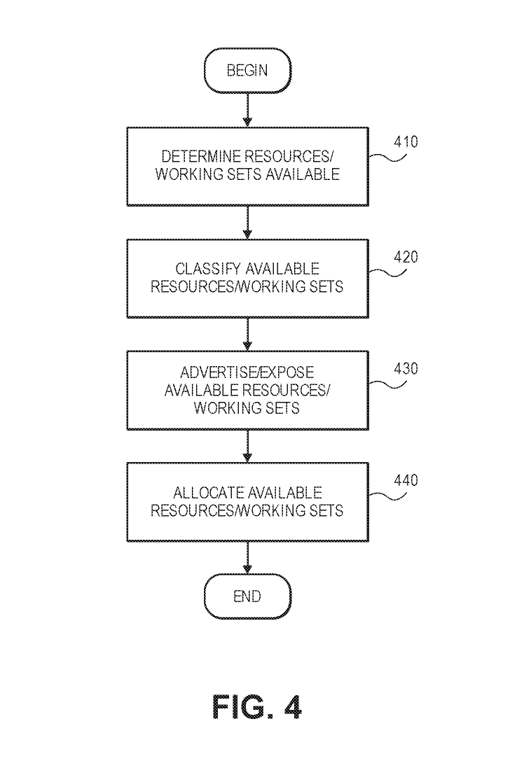

FIG. 4 is a flow diagram of one embodiment of a technique for aggregating and allocating underutilized resources. In one embodiment, the technique of FIG. 4 can be performed by one or more aggregation agents as described above. Various techniques for determining resource utilization levels as described in U.S. patent application Ser. No. ______, filed ______, 2016 and entitled “TECHNIQUES AND ARCHITECTURES FOR EFFICIENT ALLOCATION OF UNDER-UTILIZED RESOURCES,” by James Walsh and Sameer Tiwari can be utilized in conjunction with the techniques described herein.

Available resources/working sets are determined, 410. In one embodiment, the aggregation agent access resource availability information from one or more other sources. In one embodiment, the resource availability information can be acquired from one or more scavenger agents (e.g., 118 in FIG. 1). Resource/working set availability information can be acquired from other sources as well.

The available resources/working sets are classified, 420. Classification can be performed as described in greater detail above with respect to FIG. 2 and FIG. 3. In one embodiment, classification can be a dynamic process that can be updated constantly (or frequently). In another embodiment, classification can be static (or performed infrequently).

The available resources/working sets are advertised (or otherwise exposed or made available), 430. As described above, a listing of available resources/working sets can be maintained that can be matched to requests for additional resources. This can be accomplished by, for example, the aggregation agent (or alternatively by an allocation agent). Available resources/working sets are allocated to requesting systems, 440.

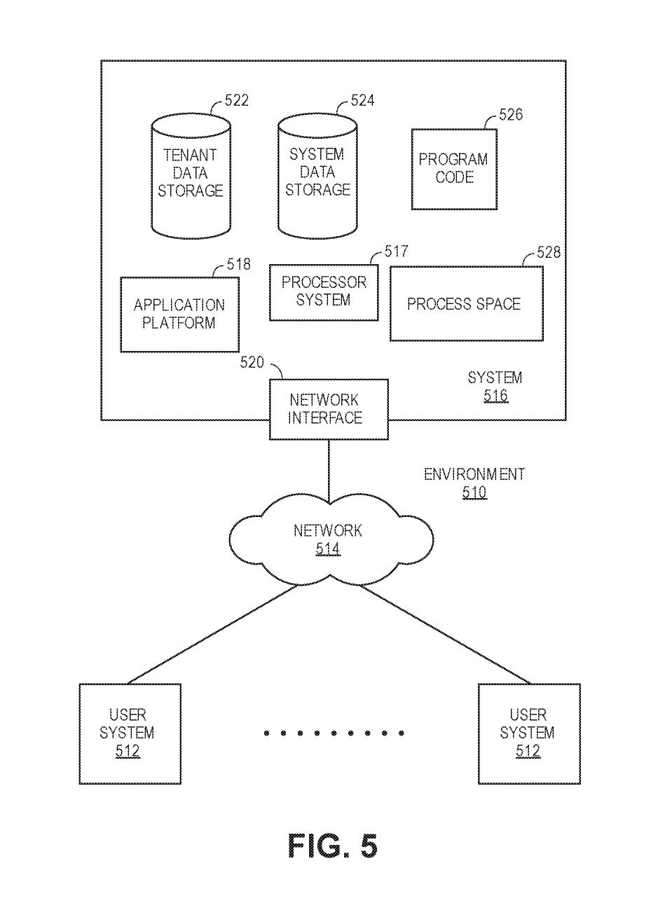

FIG. 5 illustrates a block diagram of an environment 510 wherein an on-demand database service might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

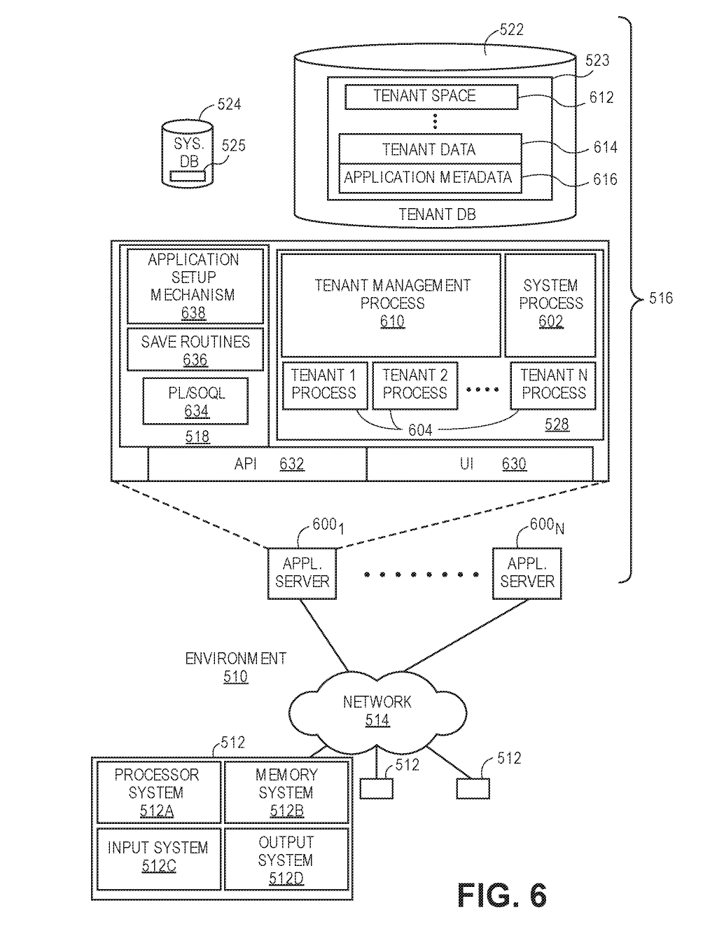

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in herein FIG. 5 (and in more detail in FIG. 6) user systems 512 might interact via a network 514 with an on-demand database service, which is system 516.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 518, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 523, system data storage 524 for system data 525 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Edge from Microsoft, Safari from Apple, Chrome from Google, or a WAP-enabled browser in the case of a cell phone, or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Core series processor or the like. Similarly, system 516 (and additional instances of an MTS, where more than one is present) and all of their components might be operator configurable using application(s) including computer code to run using a central processing unit such as processor system 517, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D. FIG. 6 shows network 514 and system 516. FIG. 6 also shows that system 516 may include tenant data storage 522, tenant data 523, system data storage 524, system data 525, User Interface (UI) 630, Application Program Interface (API) 632, PL/SOQL 634, save routines 636, application setup mechanism 638, applications servers 600₁-400_{N}, system process space 602, tenant process spaces 604, tenant management process space 610, tenant storage area 612, user storage 614, and application metadata 616. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 6, system 516 may include a network interface 520 (of FIG. 5) implemented as a set of HTTP application servers 600, an application platform 518, tenant data storage 522, and system data storage 524. Also shown is system process space 602, including individual tenant process spaces 604 and a tenant management process space 610. Each application server 600 may be configured to tenant data storage 522 and the tenant data 523 therein, and system data storage 524 and the system data 525 therein to serve requests of user systems 512. The tenant data 523 might be divided into individual tenant storage areas 612, which can be either a physical arrangement and/or a logical arrangement of data. Within each tenant storage area 612, user storage 614 and application metadata 616 might be similarly allocated for each user. For example, a copy of a user's most recently used (MRU) items might be stored to user storage 614. Similarly, a copy of MRU items for an entire organization that is a tenant might be stored to tenant storage area 612. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 604 managed by tenant management process 610 for example. Invocations to such applications may be coded using PL/SOQL 634 that provides a programming language style interface extension to API 632. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 616 for the subscriber making the invocation and executing the metadata as an application in a virtual machine.

Each application server 600 may be communicably coupled to database systems, e.g., having access to system data 525 and tenant data 523, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 BIG-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

In one embodiment, clustering techniques utilized to organize working sets can operate continuously and working set citizenship can evolve as behavior of resources changes over time, for example, as a result of upgrades or decay or load patterns.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. In a computing environment having a first plurality of executing processes each having associated resources, wherein aggregate resources for the computing environment comprise multiple different types of resources, a method comprising:
evaluating a utilization level for each of the resources within the computing environment to determine an unconsumed capacity for each of the resources below a utilization threshold, where the utilization threshold is resource-dependent;
generating one or more working sets of resources comprising unconsumed capacity of resources of a similar class;
providing the working sets to a second plurality of processes; and
executing the first plurality of processes and the second plurality of processes concurrently using the aggregate resources and at least one working set of resources.

2. The method of claim 1 wherein the resources comprise at least virtual memory capacity.

3. The method of claim 1 wherein the resources comprise at least physical memory capacity.

4. The method of claim 3 wherein the physical memory capacity comprises a persistent storage device.

5. The method of claim 4 wherein the persistent storage device comprises at least one hard disk drive (HDD).

6. The method of claim 4 wherein the persistent storage device comprises at least one solid state drive (SSD).

7. The method of claim 1 wherein the resources comprise at least virtual processor capacity.

8. The method of claim 1 wherein the resources comprise at least physical processor capacity.

9. The method of claim 1 wherein the resources comprise at least cache memory capacity.

10. The method of claim 1 wherein the resources comprise at least database capacity.

11. The method of claim 1 wherein the other executing processes are executed by different physical processors than the first plurality of executing processes.

12. A non-transitory computer-readable medium having stored thereon instructions that when executed by one or more processors in a computing environment having a first plurality of executing processes executed by the one or more processors each of the processes having associated resources, wherein aggregate resources for the computing environment comprise multiple different types of resources, the instructions, when executed by the one or more processors, are configurable to cause the one or more processors to:
evaluate a utilization level for each of the resources within the computing environment to determine an unconsumed capacity for each of the resources below a utilization threshold, where the utilization threshold is resource-dependent;
generate one or more working sets of resources comprising unconsumed capacity of resources of a similar class;
provide the working sets to a second plurality of processes; and
execute the first plurality of processes and the second plurality of processes concurrently using the aggregate resources and at least one working set of resources.

13. The non-transitory computer-readable medium of claim 12 wherein the resources comprise at least virtual memory capacity.

14. The non-transitory computer-readable medium of claim 12 wherein the resources comprise at least physical memory capacity.

15. The non-transitory computer-readable medium of claim 14 wherein the physical memory capacity comprises a persistent storage device.

16. The non-transitory computer-readable medium of claim 15 wherein the persistent storage device comprises at least one hard disk drive (HDD).

17. The non-transitory computer-readable medium of claim 15 wherein the persistent storage device comprises at least one solid state drive (SSD).

18. The non-transitory computer-readable medium of claim 12 wherein the resources comprise at least virtual processor capacity.

19. The non-transitory computer-readable medium of claim 12 wherein the resources comprise at least physical processor capacity.

20. The non-transitory computer-readable medium of claim 12 wherein the resources comprise at least cache memory capacity.

21. The non-transitory computer-readable medium of claim 12 wherein the resources comprise at least database capacity.

22. The non-transitory computer-readable medium of claim 12 wherein the other executing processes are executed by different physical processors than the first plurality of executing processes.

23. A computing environment having one or more hardware processing devices configurable to provide a first plurality of executing processes each having associated resources, wherein aggregate resources for the computing environment comprise multiple different types of resources, the one or more hardware processing devices to:
evaluate a utilization level for each of the resources within the computing environment to determine an unconsumed capacity for each of the resources below a utilization threshold, where the utilization threshold is resource-dependent;
generate one or more working sets of resources comprising unconsumed capacity of resources of a similar class;
provide the working sets to a second plurality of processes; and
execute the first plurality of processes and the second plurality of processes concurrently using the aggregate resources and at least one working set of resources.

24. The computing environment of claim 23 wherein the resources comprise at least virtual memory capacity.

25. The computing environment of claim 23 wherein the resources comprise at least physical memory capacity.

26. The computing environment of claim 25 wherein the physical memory capacity comprises a persistent storage device.

27. The computing environment of claim 26 wherein the persistent storage device comprises at least one hard disk drive (HDD).

28. The computing environment of claim 26 wherein the persistent storage device comprises at least one solid state drive (SSD).

29. The computing environment of claim 23 wherein the resources comprise at least virtual processor capacity.

30. The computing environment of claim 23 wherein the resources comprise at least physical processor capacity.

31. The computing environment of claim 23 wherein the resources comprise at least cache memory capacity.

32. The computing environment of claim 23 wherein the resources comprise at least database capacity.

33. The computing environment of claim 23 wherein the other executing processes are executed by different physical processors than the first plurality of executing processes.
